(19) United States
(12) Patent Application Publication
(10) Pub. No.: US 2024/0001351 A1
(43) Pub. Date: Jan. 4, 2024

(54) FLUID CATALYTIC CRACKING ADDITIVE COMPOSITION FOR ENHANCED BUTYLENES SELECTIVITY OVER PROPYLENE

(71) Applicant: BASF CORPORATION, Florham Park, NJ (US)

(72) Inventors: Bilge YILMAZ, Iselin, NJ (US); Vasileios KOMVOKIS, Iselin, NJ (US); Wathudura Indika Namal DE SILVA, Iselin, NJ (US); Xingtao GAO, Iselin, NJ (US)

(21) Appl. No.: 18/036,958

(22) PCT Filed: Nov. 19, 2021
(86) PCT No.: PCT/US2021/060187

§ 371 Date: May 15, 2023

Related U.S. Application Data
(60) Provisional application No. 63/116,222, filed on Nov. 20, 2020.

(51) Int. Cl. B01J 29/80; B01J 29/08; B01J 29/40; B01J 29/70; C10G 11/05; B01J 35/10

(52) U.S. Cl. CPC B01J 29/80; B01J 29/084; B01J 29/40; B01J 29/7007; C10G 11/05; B01J 35/1038; B01J 35/1014; B01J 2029/062

(57) ABSTRACT

Disclosed herein in certain embodiments is a fluid catalyst cracking (FCC) additive composition that includes a first component, a second component, and optionally a third component. The first component includes beta zeolite and a first matrix. The second component includes ZSM-5 zeolite and a second matrix. The third component includes Y zeolite and a third matrix. The components are present in the additive composition in a range that provides for enhanced butylenes to propylene selectivity ratio and total butylenes yield when catalytically cracking a hydrocarbon feed.

### CROSS-REFERENCE TO RELATED APPLICATION(S)

This application claims the benefit of priority of U.S. Provisional Patent Application No. 63/116,222, filed on Nov. 20, 2020, the disclosure of which is hereby incorporated by reference herein in its entirety.

### FIELD OF THE DISCLOSURE

The present disclosure relates to petroleum refining additives and compositions thereof. In particular, the present disclosure relates to fluid catalytic cracking (FCC) additives and compositions thereof, methods of their preparation, and methods of their use.

### BACKGROUND OF THE DISCLOSURE

FCC is the main source of world's butylenes production. Almost half of the butylenes production is sourced from FCC units, and more than 40% of it is consumed to make high octane blending components via alkylation units. Due to increasing demand for improved fuel efficiency, more and more refiners find it profitable to increase butylenes in their units. However, conventional olefin maximization additives based on ZSM-5 alone are not sufficient to meet this target. ZSM-5 additives are designed to make propylene; thus, they make more propylene over butylenes. When the units are wet-gas compressor limited the use of ZSM-5 will increase propylene more than butylenes, thus reaching the liquefied petroleum gas (LPG) limit constraints before reaching the required butylenes yields. In such a scenario the unit needs a catalyst or additive solution which contributes to increased butylenes/propylene (C4=/C3=) ratio compared to the butylenes/propylene ratio attained from a ZSM-5 based olefin additives alone.

### SUMMARY OF THE DISCLOSURE

The following summary presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

The present disclosure provides a fluid catalytic cracking (FCC) additive composition that includes a first component, a second component, and optionally a third component. The first component includes beta zeolite and a first matrix. The second component includes ZSM-5 zeolite and a second matrix. The third component includes Y zeolite and a third matrix. The third component may be included in the FCC additive composition in an amount of up to 40 wt %, based on the total weight of the FCC additive composition.

In certain embodiments, the weight ratio of the first component to the second component in the FCC additive composition ranges from about 2.5:1 to about 8.5:1, from about 3:1 to about 8:1, from about 3.5:1 to about 7:1, or from about 4:1 to about 6:1.

In certain embodiments, the weight of the first component to the second component to the third component ranges from about 2:1:1 to about 9:1:8.5, from about 2.5:1:1 to about 8.5:1:8, from about 3:1:1.5 to about 8:1:7.5, from about 3.5:1:1.5 to about 7:1:6.5, or from about 4:1:1.5 to about 6:1:5.5.

In certain embodiments, when the third component is present in the FCC additive composition, the amount of the third component is between the amount of the first component and the amount of the second component.

In certain embodiments, the first component is present in the FCC additive composition in an amount ranging from about 45 wt % to about 95 wt %, about 50 wt % to about 90 wt %, from about 55 wt % to about 85 wt %, or from about 60 wt % to about 80 wt %, based on total weight of the FCC additive composition.

In certain embodiments, the second component is present in the FCC additive composition in an amount ranging from about 5 wt % to about 25 wt %, from about 8 wt % to about 20 wt %, from about 10 wt % to about 18 wt %, or from about 12 wt % to about 15 wt %, based on total weight of the FCC additive composition.

In certain embodiments, the third component is present in the FCC additive composition in an amount ranging from about 5 wt % to about 35 wt %, from about 10 wt % to about 30 wt %, or from about 15 wt % to about 28 wt %, based on total weight of the FCC additive composition.

In certain embodiments, the FCC additive composition includes about 45 wt % to about 95 wt % of a first component that includes beta zeolite and a first matrix, about 5 wt % to about 25 wt % of a second component that includes ZSM-5 zeolite and a second matrix, and up to about 40 wt % of a third component that includes Y zeolite and a third matrix, where the weight ratio of the first component to the second component ranges from about 2:1 to about 9:1, and where all the wt % are based on the total weight of the FCC additive composition.

In certain embodiments, the FCC additive composition is free of rare earth metals.

In certain embodiments, the first matrix, the second matrix, and the third matrix comprise, independently, clay, silica stabilized gamma alumina, rare-earth doped alumina, silica-alumina, silica-doped alumina, gamma alumina, χ-alumina, δ-alumina, θ-alumina, κ-alumina, boehmite, mullite, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or a combination of any two or more thereof.

In certain embodiments, the FCC additive composition further comprises at least one additional component that is compositionally different from the first component, the second component, and the third component.

In certain embodiments, the at least one additional component may include a zeolite selected from zeolites with the structure BEA, MSE, -SVR, FAU, MOR, CON, SOF, MFI, IMF, FER, MWW, MTT, TON, EUO, MRE, NAT, CHA, or a combination thereof.

In certain embodiments, during preparation of the first component, phosphoric acid may be added to form a first component that contains oxidized phosphorus (e.g., P₂O₅). The phosphorus may be present in the first component (formed with the addition of phosphoric acid) as aluminum phosphate (AlPO₄) or as amorphous aluminum phosphate, on the beta zeolite. First components formed with the addition of phosphoric acid may be referred to herein as “first component with oxidized phosphorus.” Reference to the oxidized phosphorus in the first component may also be referred to herein as “P₂O₅” In certain embodiments, the first component includes about 1 wt % to about 30 wt %, about 2 wt % to about 25 wt %, or about 5 wt % to about 20 wt % oxidized phosphorous, based on total weight of the first component.

In certain embodiments, during preparation of the first component, silica-alumina binder treated with ammonium phosphate maybe added, as described in U.S. Pat. No. 8,940,652 B2, which is hereby incorporated by reference herein in its entirety, to form a phosphorus treated (PT) first component. First components formed with silica-alumina binder treated with ammonium phosphate may be referred to herein as “phosphorus treated (PT) first component.”

In certain embodiments, during preparation of the first component, silica-alumina binder that was not treated with ammonium phosphate (SiO₂) may be added. first components formed with silica-alumina binder without ammonium phosphate treatment may be referred to herein as “first component with SiO₂ binder.”

When the first component includes a phosphate based constituent (e.g., oxidized phosphorus or PT), the first component may be substantially free of a transitional alumina obtained by the calcination of a dispersible boehmite (such as gamma-alumina, delta alumina, or a combination thereof). It is believed that the combination of a phosphate based constituent (e.g., oxidized phosphorus or PT) with transitional alumina adversely affect the activity of the first component.

The first component may also include AlPO₄ or amorphous aluminum phosphate generated due to the interaction of boehmite, added during the preparation of the first component, and a phosphate based constituent (such as oxidized phosphorus (e.g., P₂O₅)). The amount of boehmite added during the preparation process and correspondingly the AlPO₄ content in the first component may contribute to the attrition resistance of the first component. In certain embodiments, the first component includes AlPO₄ or amorphous aluminum phosphate at an amount of about 1 wt % to about 25 wt %, about 2 wt % to about 23 wt %, or about 7 wt % to about 20 wt %, based on total weight of the first component.

In certain embodiments, the beta zeolite in the first component may have a SAR ranging from about 20 to about 300, about 25 to about 100, about 30 to about 50, or about 30 to about 40.

In certain embodiments, the zeolite surface area (ZSA) of the first component ranges from about 50 m²/g to about 300 m²/g, from about 75 m²/g to about 200 m²/g, from about 100 m²/g to about 180 m²/g, or from about 120 m²/g to about 170 m²/g, or from about 110 m²/g to about 130 m²/g. In certain embodiments, the steamed zeolite surface area (SZSA) of the first component ranges from about 50 m²/g to about 300 m²/g, from about 75 m²/g to about 140 m²/g, from about 90 m²/g to about 120 m²/g, or from about 100 m²/g to about 110 m²/g, after steaming in 100% steam at 1450° F. for 24 hours. In certain embodiments, at least about 65%, at least about 70%, or at least about 75%, at least about 80%, at least about 90%, or about 80% to about 90% of the ZSA of the first component is maintained after steaming in 100% steam at 1450° F. for 24 hours.

In certain embodiments, the Brönsted acidity of the first component ranges from about 10 μmol/g to about 65 μmol/g, from about 25 μmol/g to about 60 μmol/g, or about 35 μmol/g to about 55 μmol/g.

In certain embodiments, the air jet attrition rate (AJAR) of the first component is less than about 5 wt %/hr, less than about 4.5 wt %/hr, or less than about 4 wt %/hr.

In certain embodiments, the ratio of Zeolite Surface Area (ZSA) to Matrix Surface Area (MSA) of the zeolite in the second component is about 3 or less, about 2.8 or less, or about 2 or less.

In certain embodiments, the zeolite in the second component has a MSA ranging from about 80 m²/g to about 200 m²/g, from about 90 m²/g to about 190 m²/g, from about 100 m²/g to about 180 m²/g, or about 110 m²/g to about 170 m²/g.

In certain embodiments, the zeolite in the second component has a specific pore volume of about 0.01 cm³/g to about 0.20 cm³/g, about 0.02 cm³/g to about 0.18 cm³/g, or about 0.02 cm³/g to about 0.15 cm³/g.

In certain embodiments, the Y zeolite in the third component includes at least about 15 wt % Y-faujasite crystallized in-situ from a metakaolin-containing calcined microsphere, and the third matrix in the third component includes alumina obtained by the calcination of a dispersible boehmite contained in said microsphere. In certain embodiments, the third matrix includes at least about 5 wt %, at least about 10 wt %, or at least about 15 wt % of an alumina in a transitional gamma phase, delta phase, or a combination thereof.

Also contemplated herein, in certain embodiments, is an FCC catalyst composition that includes about 70 wt % to about 99 wt %, or about 75 wt % to about 95 wt %, or about 80 wt % to about 90 wt % of a base catalyst composition, based on total weight of the FCC catalyst composition and about 1 wt % to about 30 wt %, or about 5 wt % to about 25 wt %, or about 10 wt % to about 20 wt % of any of the FCC additive compositions described herein, based on total weight of the FCC composition

In certain aspects, the instant disclosure is directed to a method of cracking a hydrocarbon feed under FCC conditions by adding any of the FCC additive compositions described herein to a base catalyst composition in a FCC unit. The method may further include contacting the hydrocarbon feed with the base catalyst composition and the FCC additive composition. In certain embodiments, the method results in an increased total butylenes yield (TC4=yield) in the FCC unit as compared to a total butylenes yield obtained from cracking the hydrocarbon feed under FCC conditions with the base catalyst composition and without the FCC additive composition. In certain embodiments, the method results in an increased butylenes to propylene selectivity ratio in the FCC unit as compared to a butylenes to propylene selectivity ratio obtained from cracking the hydrocarbon feed under FCC conditions with the base catalyst composition and without the FCC additive composition. For instance, in certain embodiments, the method results in a butylenes to propylene selectivity ratio of about 1 or greater, about 1.05 or greater, or about 1.1 or greater. In some embodiments, the method results in substantially constant total bottoms yield as compared to a total bottoms yield obtained from cracking the hydrocarbon feed under FCC conditions with the base catalyst composition and without the FCC additive composition.

In certain aspects, the instant disclosure is directed to a method of making an FCC additive composition by blending any of the first components described herein with any of the second components described herein and optionally with any of the third components described herein. The first component includes a beta zeolite and a first matrix, the second component includes ZSM-5 zeolite and a second matrix, and the third component includes Y zeolite and a third matrix and is added in an amount of up to about 40 wt % based on the total weight of the FCC additive composition. The weight ratio of the first component to the second component ranges from about 2:1 to about 9:1. In certain embodiments, the method may further include, prior to blending, preparing one or more of the first component, the second component, or the third component.

In certain aspects, the instant disclosure is directed to a method of making an FCC catalyst composition by blending about 1 wt % to about 30 wt % of any of the FCC additive compositions described herein with about 70 wt % to about 99 wt % of a base catalyst composition.

### BRIEF DESCRIPTION OF THE DRAWINGS

The above and other features of the present disclosure, their nature, and various advantages will become more apparent upon consideration of the following detailed description, taken in conjunction with the accompanying drawings, in which:

FIG. 1 depicts a scatter plot of attrition jet index (AJI) and air jet attrition rate (AJAR) of the second component as a function of boehmite alumina content (on a volatile-free (VF) basis) used to form the second component;

FIG. 2 depicts a plot of the activity as a function of catalyst to oil ratio for various FCC additive compositions;

FIG. 3 depicts a plot of the bottoms upgrading for various FCC additive compositions;

FIG. 4 depicts a total butylenes yield as a function of conversion for various FCC additive compositions;

FIG. 5 depicts a propylene versus butylenes plot for various FCC additive compositions;

FIG. 6 depicts a pareto chart of the standardized effects of the first component, second component, and third component in the FCC additive composition on the activity of the FCC additive composition;

FIG. 7 depicts a pareto chart of the standardized effects of the first component, second component, and third component in the FCC additive composition on the bottoms upgrading of the FCC additive composition;

FIG. 8 depicts a pareto chart of the standardized effects of the first component, second component, and third component in the FCC additive composition on the total butylenes yield of the FCC additive composition; and

FIG. 9 depicts a pareto chart of the standardized effects of the first component, second component, and third component in the FCC additive composition on the butylenes to propylene selectivity ratio of the FCC additive composition.

### DEFINITIONS

As used herein, the singular forms “a,” “an,” and “the” include plural references unless the context clearly indicates otherwise. Thus, for example, reference to “a microsphere” includes a single microsphere as well as a mixture of two or more microspheres, and the like.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number±10%, such that “about 10” would include from 9 to 11.

As used herein, the term “catalyst” or “catalyst composition” or “catalyst material” or “catalyst component” refers to a material that promotes a reaction. As used herein, the term “composition,” when referring to an FCC catalyst composition or an FCC additive composition, refers to a blend or a mixture of two or more separate and distinct components, such as a first component mixed or blended with a second component. In certain embodiments, the components in the composition are chemically combined and cannot be separated through physical means (e.g., filtration). In other embodiments, the components in the composition are not chemically combined and may be separated through physical means (e.g., filtration).

As used herein, the term “fluid catalytic cracking” or “FCC” refers to a conversion process in petroleum refineries wherein high-boiling, high-molecular weight hydrocarbon fractions of petroleum crude oils are converted to more valuable gasoline, olefinic gases, and other products.

“Cracking conditions” or “FCC conditions” refers to typical FCC process conditions. Typical FCC processes are conducted at reaction temperatures of 4500 to 650° C. with catalyst regeneration temperatures of 6000 to 850° C. Hot regenerated catalyst is added to a hydrocarbon feed at the base of a riser reactor. The fluidization of the solid catalyst particles may be promoted with a lift gas. The catalyst vaporizes and superheats the feed to the desired cracking temperature. During the upward passage of the catalyst and feed, the feed is cracked, and coke deposits on the catalyst. The coked catalyst and the cracked products exit the riser and enter a solid-gas separation system, e.g., a series of cyclones, at the top of the reactor vessel. The cracked products are fractionated into a series of products, including gas, gasoline, light gas oil, and heavy cycle gas oil. Some heavier hydrocarbons may be recycled to the reactor.

As used herein, the term “feed” or “feedstock” refers to that portion of crude oil that has a high boiling point and a high molecular weight. In FCC processes, a hydrocarbon feedstock is injected into the riser section of an FCC unit, where the feedstock is cracked into lighter, more valuable products upon contacting hot catalyst circulated to the riser-reactor from a catalyst regenerator.

As used herein, “particles” can be in the form of microspheres which can be obtained by spray drying. As is understood by skilled artisans, microspheres are not necessarily perfectly spherical in shape. The various catalyst components described herein may be particles in the form of microspheres.

As used herein, the terms “matrix” or “non-zeolitic matrix” refer to the constituents of an FCC catalyst component that are not zeolites or molecular sieves.

As used herein, the term “zeolite” refers to a crystalline aluminosilicate with a framework based on an extensive three-dimensional network of silicon, aluminum and oxygen ions and have a substantially uniform pore distribution.

As used herein, the term “intergrown zeolite” refers to a zeolite that is formed by an in-situ crystallization process.

As used herein, the term “in-situ crystallized” refers to the process in which a zeolite is grown or intergrown directly on/in a microsphere and is intimately associated with the matrix or non-zeolitic material, for example, as described in U.S. Pat. Nos. 4,493,902 and 6,656,347. The zeolite is intergrown directly on/in the macropores of the precursor microsphere such that the zeolite is intimately associated is uniformly dispersed on the matrix or non-zeolitic material.

As used herein, the term “incorporated catalyst” refers to a process in which the zeolitic component is crystallized and then incorporated into microspheres in a separate step.

As used herein, the terms “preformed microspheres” or “precursor microspheres” refer to microspheres obtained by spray drying and calcining a non-zeolitic component.

As used herein, the term “zeolite-containing microsphere” refers to a microsphere obtained either by in-situ crystallizing a zeolite material on pre-formed precursor microspheres or by microspheres in which the zeolitic component is crystallized separately and then mixed with the precursor microspheres.

The terms “passivator” and “trap” are used herein interchangeably, and the composition of the present invention contains components that may passivate and/or trap the metal contaminants. “Passivator” is defined as a composition that reduces the activity of unwanted metals, i.e. nickel and vanadium to produce contaminant H2 and coke during the FCC process. While a “trap” is a composition that immobilizes contaminant metals that are otherwise free to migrate within or between microspheres in the FCC catalyst composition, i.e. V and Na.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

### DETAILED DESCRIPTION

This disclosure is directed in certain embodiments to a fluid catalytic cracking (FCC) additive composition that includes a first component, a second component, and optionally a third component. The first component includes beta zeolite and a first matrix. The second component includes ZSM-5 zeolite and a second matrix. The third component includes Y zeolite and a third matrix. The weight ratio of the first component to the second component ranges from about 2:1 to about 9:1.

This disclosure is also directed in certain embodiments to a FCC catalyst composition that includes any of the FCC additive compositions described herein and a base catalyst.

This disclosure is also directed in certain embodiments to a method of preparing any of the FCC additive compositions described herein or any of the FCC catalyst compositions described herein, including, in certain embodiments, to methods of preparing one or more of the first component, the second component, the third component, and/or any additional components that may be included in the FCC catalyst compositions described herein.

This disclosure is also directed in certain embodiments to a method of using any of the FCC additive compositions described herein or any of the FCC catalyst compositions described herein when cracking a hydrocarbon feed to increase the total butylenes yield or to improve the butylenes to propylene selectivity ratio without compromising the yield and selectivity of less desirable products, such as bottoms and coke.

Each of the first component, second component, third component, and any additional components that may be included in the additive composition of in the catalyst composition, along with methods of their preparation, will be described below separately, followed by a description of the FCC additive composition, FCC catalyst composition, and a method of their preparation and use.

### First Component

In one embodiment, the first component includes a beta zeolite and a first matrix. The first component may be a first microspheroidal particle in certain embodiments though other shapes may also be suitably used. The first component in the FCC additive composition may be formed by a process in which the zeolitic component (beta zeolite) is crystallized and then incorporated into first matrix containing microspheres in a separate step.

The first component may be present in the FCC additive composition in an amount ranging from any of about 45 wt %, about 50 wt %, about 55 wt %, about 60 wt %, about 65 wt %, about 70 wt % to any of about 75 wt %, about 80 wt %, about 85 wt %, about 90 wt %, or about 95 wt %, based on total weight of the FCC additive composition. In certain embodiments, the first component is present in the FCC additive composition in an amount ranging from about 45 wt % to about 95 wt %, from about 50 wt % to about 90 wt %, from about 55 wt % to about 85 wt %, or from about 60 wt % to about 80 wt %, or any sub-range or single value therein, based on total weight of the FCC additive composition.

In some embodiments, the first component includes a phase composition that includes from any of about 1 wt %, about 3 wt %, about 5 wt %, about 8 wt %, about 10 wt %, about 15 wt %, about 20 wt %, or about 25 wt % to any of about 30 wt %, about 35 wt %, about 40 wt %, about 45 wt %, about 50 wt %, about 55 wt %, about 60 wt %, about 70 wt %, or about 80 wt %, or any sub-range or single value therein, beta zeolite, based on total weight of the first component. In certain embodiments, the first component includes at least about 10 wt % to about 60 wt %, from about 15 wt % to about 55 wt %, from about 20 wt % to about 50 wt %, or from about 25 wt % to about 45 wt %, or any sub-range or single value therein, beta zeolite, based on total weight of the first component. In some embodiments, the first component includes phase composition of about 10 wt % to about 60 wt % beta zeolite, based on total weight of the first component. In some embodiments, the first component includes phase composition of about 15 wt % to about 55 wt % beta zeolite, based on total weight of the first component. In some embodiments, the first component includes about 25 wt % to about 45 wt % beta zeolite based on total weight of the first component. In some embodiments, the first component includes about 1 wt % to about 20 wt % beta zeolite, based on total weight of the first component. In some embodiments, the first component includes about 2 wt % to about 15 wt % beta zeolite, based on total weight of the first component. In some embodiments, the first component includes about 3 wt % to about 8 wt % beta zeolite, based on total weight of the first component.

In some embodiment described herein, the first component includes AlPO₄ or amorphous aluminum phosphate. Without being construed as limiting, it is believed that the AlPO₄ or amorphous aluminum phosphate is formed due to the inclusion of boehmite during the preparation process of the first component. Without being construed as limiting, it is believed that, at constant oxidized phosphorus (e.g., P₂O₅) loading, increased amounts of boehmite could adversely affect the beta zeolite structure by scavenging P that might otherwise have stabilized the beta zeolite structure. It is also believed that the amount of boehmite contributes to the attrition resistance of the first component. In particular, it is believed that greater amounts of boehmite may enhance the attrition resistance of the first component. Hence, the amount of boehmite used in the preparation of the first component may be tuned to be sufficiently high to generate attrition resistant first component while not being too high de-stabilize or otherwise adversely affect the beta zeolite structure. The boehmite alumina in the first component may, in certain embodiments, be different from the boehmite alumina that is used in other components (e.g., in the third component) that may be present in the FCC additive compositions or in the FCC catalyst compositions described herein.

In certain embodiments, the boehmite amount added during the preparation of the first component is sufficient to form a first component having an air jet attrition rate (AJAR), as measured according to ASTM D 5757, that is less than about 5 wt %/hr, less than about 4.5 wt %/hr, or less than about 4 wt %/hr.

In certain embodiments, the amount of AlPO₄ and/or amorphous aluminum phosphate in the first component may range from any of about 1 wt %, about 2 wt %, about 3 wt %, about 4 wt %, about 5 wt %, about 6 wt %, about 7 wt %, about 8 wt %, about 9 wt %, about 10 wt %, about 11 wt %, or about 12 wt % to any of about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, or about 25 wt %, based on total weight of the first component. In some embodiments, the amount of AlPO₄ and/or amorphous in the first component ranges from about 1 wt % to about 25 wt %, from about 5 wt % to about 23 wt %, from about 10 wt % to about 20 wt %, or from about 13 wt % to about 17 wt %, or any sub-range or single value therein, based on total weight of the first component.

In some embodiments, the first component includes one or more of oxidized phosphorus (e.g., P₂O₅), phosphate treated constituent (PT), or a silica-alumina binder. In one embodiment, the first component includes oxidized phosphorus (e.g., P₂O₅). In one embodiment, the first component includes a phosphate treated constituent (PT). In one embodiment, the first component includes a silica-alumina binder.

Without being construed as limiting, it is believed that the binder type may indirectly contribute to the Brönsted acidity of the first component, which may be a reflection of the butylenes related activity of the second component. It was observed, in certain embodiments, that a first component that included oxidized phosphorus (e.g., P₂O₅) had a higher Brönsted acidity than a first component that included a silica-alumina binder. It was further observed, in certain embodiments, that a first component that included a silica-alumina binder had a higher Brönsted acidity than a first component that included P treated beta zeolite. In certain embodiments, the Brönsted acidity of the first component may range from about 10 μmol/g to about 65 μmol/g, from about 25 μmol/g to about 60 μmol/g, or about 35 μmol/g to about 55 μmol/g, or any sub-range or single value therein. In certain embodiments, the first component includes oxidized phosphorus (e.g., P₂O₅) and has a Brönsted acidity of about 35 μmol/g to about 55 μmol/g. In certain embodiments, the first component includes a silica-alumina binder and has a Brönsted acidity of about 25 μmol/g to about 40 μmol/g. In certain embodiments, the first component includes P treated beta zeolite and has a Brönsted acidity of about 10 μmol/g to about 25 μmol/g.

In certain embodiments, the first component includes oxidized phosphorus (e.g., P₂O₅) in an amount of from any of about 1 wt %, about 2 wt %, about 3 wt %, about 4 wt %, about 5 wt %, about 6 wt %, about 7 wt %, about 8 wt %, about 9 wt %, or about 10 wt % to any of about 11 wt %, about 12 wt %, about 13 wt %, about 14 wt %, about 15 wt %, about 16 wt %, about 17 wt %, about 18 wt %, about 19 wt %, or about 20 wt %, based on total weight of the first component. In certain embodiments, the first component includes oxidized phosphorus (e.g., P₂O₅) in an amount of about 1 wt % to about 30 wt %, about 2 wt % to about 25 wt %, about 5 wt % to about 20 wt %, or any sub-range or single value therein, based on total weight of the first component. Without being construed as limiting, it is believed that the inclusion of oxidized phosphorus (e.g., P₂O₅) in the first component reduces the amount/dose of first component required to give a 1 wt % of incremental increase in overall butylenes yield, as quantified upon contacting the first component with a hydrocarbon feed, when compared to the amount/dose required to generate a similar butylenes yield improvement with an identical first component that does not include oxidized phosphorus (e.g., P₂O₅).

In certain embodiments, the first component is substantially free of a transitional alumina, obtained by the calcination of a dispersible boehmite, such as gamma alumina, delta alumina, or a combination thereof. The term “substantially free,” as used herein, refers to the first component having less than about 5 wt %, less than about 4 wt %, less than about 3 wt %, less than about 2 wt %, less than about 1 wt %, or 0 wt % of a transitional alumina, obtained by the calcination of a dispersible boehmite, based on the total weight of the first component. Without being construed as limiting, it is believed that the combination of beta zeolite, oxidized phosphorus such as P₂O₅ (or a different P based component), and transitional alumina (such as gamma alumina, delta alumina, or a combination thereof) adversely effects/diminishes the performance of beta zeolite. Hence, in certain embodiments, the second component includes a combination of beta zeolite and oxidized phosphorus (e.g., P₂O₅) or a combination of beta zeolite and a transitional alumina (such as gamma alumina, delta alumina, or a combination thereof) but not the combination of oxidized phosphorus (e.g., P₂O₅) and the transitional alumina (such as gamma alumina, delta alumina, or a combination thereof). In one embodiment, the first component includes beta zeolite and oxidized phosphorus (e.g., P₂O₅) while being substantially free of transitional alumina (such as gamma alumina, delta alumina, or a combination thereof). In one embodiment, the first component includes beta zeolite, the transitional alumina (such as gamma alumina, delta alumina, or a combination thereof), and optionally a silica-alumina binder.

The silica to alumina ratio (SAR) in the beta zeolite in the first component ranges from any of about 20, about 25, about 30, or about 35 to any of about 40, about 50, about 75, about 100, about 150, about 200, about 250, or about 300. In certain embodiments, the SAR in the zeolite in the first component is from about 20 to about 300, from about 25 to about 100, from about 30 to about 50, or from about 30 to about 40. In certain embodiments, the first component is treated with phosphoric acid to bind oxidized phosphorus (e.g., P₂O₅) thereto and the beta zeolite has a SAR that is greater than about 30. Without being construed as limiting, it is believed that the SAR can be an important parameter which affects beta zeolite stability and activity. The SAR value should balance between maintaining the stability of the beta zeolite structure and the butylenes activity thereof.

The adverse effect on the beta zeolite may be evidenced by the zeolite surface area (ZSA) of the first component prior to steaming, the steamed zeolite surface area (SZSA) of the first component, and/or the comparison between the SZSA and the ZSA of the first component.

In certain embodiments, the ZSA of the first component ranges from any of about 50 m²/g, about 75 m²/g, about 100 m²/g, about 110 m²/g, or about 120 m²/g to any of about 130 m²/g, about 140 m²/g, about 150 m²/g, about 170 m²/g, about 180 m²/g, about 200 m²/g, about 250 m²/g, or about 300 m²/g. In some embodiments, the ZSA of the first component ranges from about 50 m²/g to about 300 m²/g, from about 75 m²/g to about 200 m²/g, from about 100 m²/g to about 180 m²/g, from about 120 m²/g to about 170 m²/g, or from about 110 m²/g to about 130 m²/g, or any sub-range or single value therein.

In certain embodiments, the SZSA of the first component, after steaming in 100% steam at 1450° F. for 24 hours, ranges from any of about 50 m²/g, about 60 m²/g, about 70 m²/g, about 75 m²/g, about 80 m²/g, about 90, or about 100 m²/g, to any of about 110 m²/g, about 120 m²/g, about 130 m²/g, about 140 m²/g, about 150 m²/g, about 170 m²/g, about 180 m²/g, about 200 m²/g, about 250 m²/g, or about 300 m²/g. In some embodiments, the SZSA of the first component, after steaming in 100% steam at 1450° F. for 24 hours, ranges from about 50 m²/g to about 300 m²/g, from about 75 m²/g to about 140 m²/g, from about 90 m²/g to about 120 m²/g, or from about 100 m²/g to about 110 m²/g, or any sub-range or single value therein.

In certain embodiments, a majority of the ZSA of the first component is retained after steaming. For instance, at least about 65%, at least about 70%, at least about 75%, at least about 80%, at least about 85%, at least about 90%, or from about 80 to about 90%, of the ZSA of the first component is retained after steaming in 100% steam at 1450° F. for 24 hours. Without being construed as limiting, it is believed that increasing the content of oxidized phosphorus (e.g., P₂O₅) in the first component improves beta zeolite structure retention, as evidenced at least by the comparison of SZSA to ZSA.

Without being construed as limiting, it is believed that the butylenes activity (quantified as amount of butylenes per dose of the first component that is generated upon contacting at least the first component with a hydrocarbon feed), increases with increasing oxidized phosphorus (e.g., P₂O₅) content and/or with increased ZSA and/or with increased SZSA.

In certain embodiments, the first matrix of the first component further includes kaolin. In certain embodiments, the first component includes beta zeolite in combination with kaolin, AlPO₄ and/or amorphous aluminum phosphate (formed from boehmite and phosphoric acid), and oxidized phosphorus (e.g., P₂O₅) while being substantially free of transitional alumina (such as gamma alumina, delta alumina, or a combination thereof).

In certain embodiments, the first matrix of the first component may include, clay, silica stabilized gamma alumina, rare-earth doped alumina (e.g., selected from one or more of ytterbium-doped alumina, gadolinium-doped alumina, cerium-doped alumina, or lanthanum-doped alumina), silica-alumina, silica-doped alumina, gamma alumina, χ-alumina, δ-alumina, θ-alumina, κ-alumina, boehmite, mullite, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or a combination of any two or more thereof.

In some embodiments, the first component includes from any of about 1 wt %, about 3 wt %, about 5 wt %, about 8 wt %, about 10 wt %, about 15 wt %, about 20 wt %, or about 25 wt % to any of about 30 wt %, about 35 wt %, about 40 wt %, about 45 wt %, about 50 wt %, about 60 wt %, about 70 wt %, about 80 wt %, or about 90 wt % of the first matrix, based on total weight of the first component. In certain embodiments, the first component includes about 1 wt % to about 80 wt %, about 5 wt % to about 60 wt %, about 10 wt % to about 70 wt %, about 10 wt % to about 40 wt %, or any sub-range or single value therein, of the first matrix, based on total weight of the first component.

In certain embodiments, the first component may further include, as part of the beta zeolite and/or as part of the first matrix, a rare earth element, an alkaline earth element, or a mixture of two or more such elements. Suitable rare earth elements include ytterbium, gadolinium, cerium, lanthanum, praseodynmium, neodymium, or a mixture of any two or more thereof. Suitable alkaline earth elements include barium, calcium, strontium, magnesium, or a mixture of any two or more thereof. In certain embodiments, the first component may be modified by other suitable cations (e.g., iron).

In some embodiments, the first component's average particle size may be from about 30 to about 250 micrometers. In some embodiments, the first component's average particle size may be from about 60 to about 100 micrometers. In some embodiments, the first component has an average particle size of about 60 to about 90 micrometers. In some embodiments, the first component has an average particle size of about 60 to about 80 micrometers.

In certain embodiments, the first component may be formed by slurry blending beta zeolite with a first non-zeolitic material to form a slurry. The first non-zeolitic material (also referred to as first matrix) may include boehmite alumina and kaolin in certain embodiments. In other embodiments, the first non-zeolitic material (or first matrix) may include boehmite alumina, α-alumina, and kaolin. The process of forming the first component may also include spray drying the slurry.

In certain embodiments, the process of forming the first component may also include adding (e.g., injecting) phosphoric acid (H₃PO₄) during the spray drying.

As indicated earlier, the amount of boehmite and the amount of phosphoric acid that is added during the preparation of the first component is tuned to generate a first component that maintains its zeolite structure (evidenced by ZSA and SZSA), maintains its attrition resistance (evidenced by AJAR), and maintains its activity (evidenced by total butylenes yield). In certain embodiments, the amount of boehmite added to the slurry ranges from any of about 1 wt %, about 2 wt %, about 3 wt %, about 4 wt %, or about 5 wt % to any of about 6 wt %, about 7 wt %, about 8 wt %, about 9 wt %, or about 10 wt %, based on total weight of the slurry. In some embodiments, the amount of boehmite added to the slurry is from about 1 wt % to about 10 wt %, from about 3 wt % to about 9 wt %, or from about 5 wt % to about 8 wt %, or any sub-range or single value therein, based on the total weight of the slurry.

In certain embodiments, the process of forming the first component includes calcining the spray dried, and optionally oxidized phosphorus (e.g., P₂O₅) containing, first microspheroidal particles, to form the first component. In some embodiments, the calcining is conducted for at least about two hours. Such calcining may be conducted at a temperature of from about 500° C. to about 900° C., or about 700° C. The calcination temperature and duration should not be construed as limiting. Under various circumstances, other calcination durations and temperatures may be utilized.

The method may further include steam-treating the first component. In some embodiments, the steam-treating is conducted at a temperature of at least about 700° C. In some embodiments, the steam-treating is conducted for at least about four hours. In some embodiments, the steam-treating is conducted for about one to about 24 hours. The steam treatment temperature and duration should not be construed as limiting. Under various circumstances, other steam treatment durations and temperatures may be utilized.

### Second Component

In one embodiment, the second component includes a ZSM-5 zeolite and a second matrix. The second component may be second microspheroidal particles in certain embodiments though other shapes may also be suitably used.

The second component may be present in the FCC additive composition in an amount ranging from any of about 5 wt %, about 6 wt %, about 7 wt %, about 8 wt %, about 9 wt %, about 10 wt %, about 11 wt %, about 12 wt %, or about 13 wt % to any of about 14 wt %, about 15 wt %, about 16 wt %, about 17 wt %, about 18 wt %, about 19 wt %, about 20 wt %, about 21 wt %, about 22 wt %, about 23 wt %, about 24 wt %, or about 25 wt %, based on total weight of the FCC additive composition. In certain embodiments, the second component is present in the FCC additive composition in an amount ranging from about 5 wt % to about 25 wt %, from about 8 wt % to about 20 wt %, from about 10 wt % to about 18 wt %, or from about 12 wt % to about 15 wt %, or any sub-range or single value therein, based on total weight of the FCC additive composition.

In certain embodiments, the ZSM-5 zeolite in the second component has a medium to high mesoporosity. The high mesoporosity of the ZSM-5 zeolite in the second component may be evident from the high ratio of the ZSM-5 zeolite's total surface area (TSA) to the ZSM-5 zeolite's matrix surface area (MSA) (i.e., high TSA/MSA) or said differently the ZSM-5 zeolite's low zeolite surface area (ZSA) to MSA (i.e., low ZSA/MSA). The ZSM-5 zeolite's ZSA is the difference between the TSA and the MSA. In certain embodiments, the ZSM-5 zeolite in the second component has a ratio of ZSA/MSA of about 3 or less, about 2.8 or less, or about 2 or less. For instance, the ZSM-5 zeolite's ZSA/MSA may range from about 1.2 to about 3, from about 1.3 to about 2.8, or from about 1.4 to about 2, or any sub-range or single value therein.

In certain embodiments, the MSA of the ZSM-5 zeolite in the second component ranges from any of about 80 m²/g, about 90 m²/g, about 100 m²/g, about 120 m²/g, about 130 m²/g, about 135 m²/g, about 140 m²/g, about 145 m²/g, about 150 m²/g, about 155 m²/g, or about 160 m²/g to any of about 165 m²/g, about 170 m²/g, about 175 m²/g, about 180 m²/g, about 185 m²/g, about 190 m²/g. In certain embodiments, the MSA of the ZSM-5 zeolite in the second component ranges from about 80 m²/g to about 190 m²/g, from about 90 m²/g to about 180 m²/g, from about 100 m²/g to about 170 m²/g, or any sub-range or single MSA value therein.

In certain embodiments, the TSA of the ZSM-5 zeolite in the second component ranges from any of about 300 m²/g, about 325 m²/g, about 340 m²/g, about 350 m²/g, about 360 m²/g, about 365 m²/g, about 370 m²/g, about 375 m²/g, about 380 m²/g, about 385 m²/g, or about 390 m²/g to any of about 395 m²/g, about 400 m²/g, about 405 m²/g, about 410 m²/g, about 415 m²/g, about 420 m²/g, about 425 m²/g, or about 430 m²/g. In certain embodiments, the TSA of the ZSM-5 zeolite in the second component ranges from about 300 m²/g to about 430 m²/g, from about 320 m²/g to about 420 m²/g, from about 330 m²/g to about 410 m²/g, or from about 340 m²/g to about 400 m²/g, or any sub-range or single TSA value therein.

It is believed that the higher TSA of the ZSM-5 zeolite in the second component described herein, in certain embodiment, occurs due to secondary pores, which contribute to improved butylenes to propylene selectivity of such second components as compared to catalyst components that include ZSM-5 zeolite but have a lower TSA values than those described herein.

In certain embodiments, the zeolite in the second component has a specific pore volume ranging from any of about 0.02 cm³/g, about 0.03 cm³/g, about 0.05 cm³/g, about 0.06 cm³/g, about 0.07 cm³/g, about 0.08 cm³/g, about 0.09 cm³/g, or about 0.10 cm³/g to any of about 0.11 cm³/g, about 0.12 cm³/g, about 0.13 cm³/g, about 0.14 cm³/g, or about 0.15 cm³/g. In certain embodiments, the zeolite in the second component has a specific pore volume ranging from about 0.02 cm³/g to about 0.20 cm³/g, about 0.05 cm³/g to about 0.18 cm³/g, or about 0.10 cm³/g to about 0.15 cm³/g, or any sub-range or single specific pore volume value therein.

In one embodiment, the second component has a phase composition including from any of about 10 wt %, about 20 wt %, about 30 wt %, about 40 wt %, about 50 wt %, about 55 wt %, about 60 wt %, about 65 wt %, or about 70 wt % to any of about 75 wt %, about 80 wt %, about 85 wt %, about 90 wt %, about 92 wt %, about 95 wt %, about 97 wt %, or about 99 wt % ZSM-5 zeolite, based on the total weight of the second component. In one embodiments, the second component has a phase composition including at least about 10 wt % ZSM-5 zeolite, based on the total weight of the second component. In one embodiments, the second component has a phase composition including at least about 40 wt % ZSM-5 zeolite, based on the total weight of the second component. In one embodiments, the second component has a phase composition including at least about 60 wt % ZSM-5 zeolite, based on the total weight of the second component. In one embodiments, the second component has a phase composition including at least about 65 wt % ZSM-5 zeolite, based on the total weight of the second component.

In certain embodiments, the second matrix of the second component may include, clay, silica stabilized gamma alumina, rare-earth doped alumina (e.g., selected from one or more of ytterbium-doped alumina, gadolinium-doped alumina, cerium-doped alumina, or lanthanum-doped alumina), silica-alumina, silica-doped alumina, gamma alumina, χ-alumina, δ-alumina, θ-alumina, κ-alumina, boehmite, mullite, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or a combination of any two or more thereof.

In some embodiments, the second component includes from any of about 1 wt %, about 3 wt %, about 5 wt %, about 8 wt %, about 10 wt %, about 15 wt %, about 20 wt %, or about 25 wt % to any of about 30 wt %, about 35 wt %, about 40 wt %, about 45 wt %, about 50 wt %, about 60 wt %, about 70 wt %, about 80 wt %, or about 90 wt % of the second matrix, based on total weight of the second component. In certain embodiments, the second component includes about 1 wt % to about 80 wt %, about 5 wt % to about 60 wt %, about 10 wt % to about 70 wt %, about 10 wt % to about 40 wt %, or any sub-range or single value therein, of the second matrix, based on total weight of the second component.

In certain embodiments, the second component may further include, as part of the ZSM-5 zeolite and/or as part of the second matrix, a rare earth element, an alkaline earth element, or a mixture of two or more such elements. Suitable rare earth elements include ytterbium, gadolinium, cerium, lanthanum, praseodynmium, neodymium, or a mixture of any two or more thereof. Suitable alkaline earth elements include barium, calcium, strontium, magnesium, or a mixture of any two or more thereof. In certain embodiments, the second component may be modified by other suitable cations (e.g., iron).

In some embodiments, the second component's average particle size may be from about 30 to about 250 micrometers. In some embodiments, the second component's average particle size may be from about 60 to about 100 micrometers. In some embodiments, the second component has an average particle size of about 60 to about 90 micrometers. In some embodiments, the second component has an average particle size of about 60 to about 80 micrometers.

### Third Component

In one embodiment, the third component includes a Y zeolite and a third matrix. The third component may be third microspheroidal particles in certain embodiments though other shapes may also be suitably used.

The third component may be present in the FCC additive composition in an amount ranging from any of 0 wt %, about 5 wt %, about 10 wt %, about 15 wt %, about 20 wt %, or about 25 wt % to any of about 28 wt %, about 30 wt %, about 33 wt %, about 35 wt %, about 38 wt %, or about 40 wt %, based on total weight of the FCC additive composition. In certain embodiments, the third component is present in the FCC additive composition in an amount ranging from about 5 wt % to about 35 wt %, from about 10 wt % to about 30 wt %, or from about 15 wt % to about 28 wt %, or any sub-range or single value therein, based on total weight of the FCC additive composition. In an embodiment, the third component may be present in the FCC additive composition in an amount of up to 40 wt %, based on the total weight of the FCC additive composition. In an embodiment, the FCC additive composition is free of a third component.

In one embodiment, the third component includes a Y-faujasite crystallized in-situ from a metakaolin-containing calcined microsphere. In certain embodiments, the third component has a phase composition including from any of about 10 wt %, about 20 wt %, about 30 wt %, about 40 wt %, about 50 wt %, about 55 wt %, about 60 wt %, about 65 wt %, or about 70 wt % to any of about 75 wt %, about 80 wt %, about 85 wt %, about 90 wt %, about 92 wt %, about 95 wt %, about 97 wt %, or about 99 wt % Y-zeolite, based on the total weight of the third component. In one embodiments, the third component has a phase composition including at least about 10 wt % Y zeolite, based on the total weight of the third component. In one embodiments, the third component has a phase composition including at least about 40 wt % Y zeolite, based on the total weight of the third component. In one embodiments, the third component has a phase composition including at least about 60 wt % Y zeolite, based on the total weight of the third component. In one embodiments, the third component has a phase composition including at least about 65 wt % Y zeolite, based on the total weight of the third component.

The terms Y-faujasite or Y zeolite shall encompass the zeolite in its sodium form as well as in the known modified forms, including, e.g., rare earth and ammonium exchanged forms and stabilized forms. The percentage of Y-faujasite zeolite in the microspheres of the catalyst is determined when the zeolite is in the sodium form (after it has been washed to remove any crystallization mother liquor contained within the microspheres) by the technique described in the ASTM standard method of testing titled “Relative Zeolite Diffraction Intensities” (Designation D3906-80) or by an equivalent technique.

In some embodiments, the Y zeolite of the third component may be ion exchanged to reduce the sodium content of said third component to less than about 0.5 wt %, less than about 0.4 wt %, or less than about 0.3 wt %, based on the total weight of the third component.

In one embodiment, the Y-faujasite of the third component, in their sodium form, has a crystalline unit cell size of less than about 24.75 Å, less than about 24.73 Å, less than about 24.69 Å, less than about 24.65 Å, less than about 24.60 Å, less than about 24.55 Å, or about 24.25 Å to about 24.70 Å.

The third component further includes a third matrix. In certain embodiments, the third matrix of the third component may include, clay, silica stabilized gamma alumina, rare-earth doped alumina (e.g., selected from one or more of ytterbium-doped alumina, gadolinium-doped alumina, cerium-doped alumina, or lanthanum-doped alumina), silica-alumina, silica-doped alumina, gamma alumina, χ-alumina, δ-alumina, θ-alumina, κ-alumina, boehmite, mullite, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or a combination of any two or more thereof.

In certain embodiments, the third matrix includes a transitional alumina phase (e.g., gamma alumina, delta alumina, or a combination thereof that results from the calcination of the dispersible crystalline boehmite during the preparation procedure). Such third matrix can passivate the Ni and V that are deposited on to the third component during the cracking process, especially during cracking of heavy residuum feeds. Contaminant coke and hydrogen arise due to the presence of Ni and V and reduction of these byproducts significantly improves FCC operation. Y zeolites with such matrices are described for instance, in U.S. Pat. Nos. 10,633,596, 6,673,235, and 6,716,338, the disclosures of which are hereby incorporated by reference herein in their entirety. In certain embodiments, the third matrix includes at least about 5 wt %, at least about 10 wt %, or at least about 15 wt % of a transitional alumina phase including gamma alumina, delta alumina, or a combination thereof, that has metal passivating and/or trapping functionality.

In some embodiments, the third component includes from any of about 1 wt %, about 3 wt %, about 5 wt %, about 8 wt %, about 10 wt %, about 15 wt %, about 20 wt %, or about 25 wt % to any of about 30 wt %, about 35 wt %, about 40 wt %, about 45 wt %, about 50 wt %, about 60 wt %, about 70 wt %, about 80 wt %, or about 90 wt % of the third matrix, based on total weight of the third component. In certain embodiments, the third component includes about 1 wt % to about 80 wt %, about 5 wt % to about 60 wt %, about 10 wt % to about 70 wt %, about 10 wt % to about 40 wt %, or any sub-range or single value therein, of the third matrix, based on total weight of the third component.

In certain embodiments, the third component may further include, as part of the Y zeolite or as part of the third matrix, a rare earth element, an alkaline earth element, or a mixture of two or more such elements. Suitable rare earth elements include ytterbium, gadolinium, cerium, lanthanum, praseodynmium, neodymium, or a mixture of any two or more thereof. Suitable alkaline earth elements include barium, calcium, strontium, magnesium, or a mixture of any two or more thereof. In certain embodiments, the third component may be modified by other suitable cations (e.g., iron).

The zeolitic constituent of the third component may be formed by one of two general techniques. In one technique, the zeolitic constituent (e.g., zeolite Y) is crystallized and then incorporated into microspheres that include the third matrix in a separate step. In a second technique, the in-situ technique, precursor microspheres are first formed and the zeolitic constituent (e.g., zeolite Y) is then crystallized in-situ in the microspheres themselves to provide a third catalyst component in the form of microspheres, which contains the zeolitic constituent (e.g., zeolite Y) and the non-zeolitic matrix (e.g., third matrix).

Preparation of the third component, in accordance with one embodiment of this disclosure, involves an initial step of pre-forming microspheres including a non-zeolitic constituent. For instance, the non-zeolitic constituent in the precursor microspheres may include hydrous kaolin clay and/or metakaolin, a dispersible crystalline boehmite (Al₂O₃, H₂O), optionally spinel and/or mullite, and a sodium silicate or silica sol binder. The precursor microspheres may be calcined to convert any hydrous kaolin component to metakaolin. The calcination process can transform the dispersible boehmite into a transitional alumina phase (e.g., gamma alumina).

Preparation of the third component, in accordance with this embodiment, further involves mixing the calcined precursor microspheres with an alkaline sodium silicate solution (e.g., sodium silicate, sodium hydroxide, and water) to form an alkaline slurry. The process may further include heating the alkaline slurry to a temperature, and for a time, sufficient to crystallize, in-situ, a target phase concentration of NaY-zeolite in the third component microspheres.

The third component microspheres may be isolated or separated from the crystallization liquor. The isolation may be carried out by commonly used methods such as filtration. In certain embodiments, the third component microspheres may be washed or contacted with water or another suitable liquid to remove residual crystallization liquor.

In certain embodiments, sodium cations in the third component microspheres may be replaced with more desirable cations. This may be accomplished by contacting the third component microspheres with solutions containing ammonium or rare earth cations or both. The ion exchange step or steps are preferably carried out so that the resulting third catalyst component contains less than about 0.7 wt % a, less than about 0.5 wt %, less than about 0.4 wt %, or less than about 0.3 wt %, Na₂O and optionally about 0.1 wt % to about 12 wt % or about 0.5 wt % to about 7 wt % of a rare earth oxide. The contacting with ammonium solution may be done as acidic pH conditions (e.g., pH of about 3 to about 3.5) and at a temperature above room temperature (e.g., about 80° C. to about 100° C.).

After ion exchange, the third component microspheres are dried and calcined to obtain the third component microspheres that may be utilized in the FCC additive compositions of the present disclosure. Suitable calcination temperatures may range from about 500° C. to about 750° C., in the present of 25% v/v steam. It should be understood that the calcination conditions (e.g., temperature, duration, and steam content) may vary and are not limiting. Under various circumstances, other calcination conditions may be utilized.

The method may further include steam-treating the third component. In some embodiments, the steam-treating is conducted at a temperature of at least about 700° C. In some embodiments, the steam-treating is conducted for at least about four hours. In some embodiments, the steam-treating is conducted for about one to about 24 hours. The steam treatment temperature and duration should not be construed as limiting. Under various circumstances, other steam treatment durations and temperatures may be utilized.

Alternatively, the Y-zeolite may be produced into high zeolite content microspheres by the in-situ procedure described in U.S. Pat. No. 4,493,902 (“the '902 patent”). The '902 patent discloses FCC catalysts including attrition-resistant, high zeolitic content, catalytically active microspheres containing more than about 40%, preferably 50-70% by weight Y faujasite and methods for making such catalysts by crystallizing more than about 40% sodium Y-zeolite in porous microspheres composed of a mixture of metakaolin (kaolin calcined to undergo a strong endothermic reaction associated with dehydroxylation) and kaolin calcined under conditions more severe than those used to convert kaolin to metakaolin, i.e., kaolin calcined to undergo the characteristic kaolin exothermic reaction, sometimes referred to as the spinel form of calcined kaolin. The microspheres containing the two forms of calcined kaolin could also be immersed in an alkaline sodium silicate solution, which is heated, preferably until the maximum obtainable amount of Y faujasite is crystallized in the microspheres. The microspheres are separated from the sodium silicate mother liquor, ion-exchanged with rare earth, ammonium ions or both to form rare earth or various known stabilized forms of catalysts.

The Y-zeolite may also be produced as zeolite microspheres, which are disclosed in U.S. Pat. No. 6,656,347 (“the '347 patent”) and U.S. Pat. No. 6,942,784 (“the '784 patent”). These zeolite microspheres are macroporous, have sufficient levels of zeolite to be very active and are of a unique morphology to achieve effective conversion of hydrocarbons to cracked gasoline products with improved bottoms cracking under short contact time FCC processing. These zeolite microspheres are produced by a modification of technology described in the '902 patent.

In some embodiments, the third component's average particle size may be from about 30 to about 250 micrometers. In some embodiments, the third component's average particle size may be from about 60 to about 100 micrometers. In some embodiments, the third component has an average particle size of about 60 to about 90 micrometers. In some embodiments, the third component has an average particle size of about 60 to about 80 micrometers.

### Additional Components

The FCC additive compositions or the FCC catalyst compositions described herein may further include at least one additional component. The at least one additional component may be compositionally different from the first component, from the second component, and from the third component if present.

The at least one additional component may include a zeolite constituent and a non-zeolitic matrix. The zeolite constituent may be selected from zeolites with the structure BEA (e.g., beta zeolite), MSE, -SVR, FAU (e.g., zeolite Y), MOR, CON, SOF, MFI (e.g., ZSM-5), IMF, FER, MWW, MTT, TON, EUO, MRE, NAT, CHA, or a combination thereof.

In certain embodiments, the zeolite constituent in the at least one additional component may include (1) large pore zeolites (e.g., those having pore openings greater than about 7 Å) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite Z, zeolite Y, dealuminated zeolite Y, silica-enriched dealuminated zeolite Y, zeolite Beta, ZSM-3, ZSM-4, ZSM-18 and ZSM-20, (2) medium pore zeolites (e.g., those having pore openings of from about 4 Angstroms to about 7 Angstroms) such as, for example, ZSM-5, MCM-68, ZSM-11, ZSM-5, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34.

In certain embodiments, the zeolite constituent in the at least one additional component may include zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

Hydrothermally and/or chemically modified versions of many of the components described above may also be suitable as the at least one additional component in the FCC additive compositions or in the FCC catalyst compositions contemplated herein.

In some embodiments, the zeolite constituent in the at least one additional component may include at least one zeolite selected from ZSM-5, mordenite, ferrierite, MCM-22, MCM-68, Y-zeolite, beta zeolite, or a combination of two or more thereof.

In certain embodiments, the non zeolitic matrix in the at least one additional component may include, clay, silica stabilized gamma alumina, rare-earth doped alumina (e.g., selected from one or more of ytterbium-doped alumina, gadolinium-doped alumina, cerium-doped alumina, or lanthanum-doped alumina), silica-alumina, silica-doped alumina, gamma alumina, χ-alumina, δ-alumina, θ-alumina, κ-alumina, boehmite, mullite, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or a combination of any two or more thereof.

In certain embodiments, the at least one additional component may further include, as part of the zeolitic constituent or as part of the non-zeolitic matrix matrix, a rare earth element, an alkaline earth element, or a mixture of two or more such elements. Suitable rare earth elements include ytterbium, gadolinium, cerium, lanthanum, praseodynmium, neodymium, or a mixture of any two or more thereof. Suitable alkaline earth elements include barium, calcium, strontium, magnesium, or a mixture of any two or more thereof.

In certain embodiments, the at least one additional component may have metal passivating and/or metal trapping functionality. For instance, the at least one additional component may be a metal passivator and/or a metal trap, such as those described in, e.g., U.S. Patent Application Publication No. 2015/75899, U.S. Pat. Nos. 9,637,688, 9,796,932, and/or U.S. Patent Application Publication No. 2015/0174560, the disclosures of which are hereby incorporated by reference herein in their entireties.

### FCC Additive Composition

In certain embodiments, the instant disclosure is directed to an FCC additive composition that includes any of the first components described herein in combination with any of the second components described herein and optionally in combination with any of the third components described herein. The first component, the second component, and the third component may be formulated as separate and distinct microspheroidal particles, e.g., a first amount of the first microspheroidal particles, a second amount of second microspheroidal particles, and a third amount of third microspheroidal particles. The first microspheroidal particles, corresponding to the first component, could include beta zeolite and a first matrix, the second microspheroidal particles, corresponding to the second component, could include ZSM-5 zeolite and a second matrix, and the third microspheroidal particles, corresponding to the third component, could include Y zeolite and a third matrix.

The various components may be formulated as separate and distinct particles, which allows to add them to the FCC additive composition as needed to provide a customized additive solution. For instance, the first components described herein are believed to be a significant contributor to the butylenes specific activity of the FCC additive composition. However, the first components described herein are also believed to be a significant contributor to the bottoms upgrading of the FCC additive composition. Both, the first component and the second component are believed to be significant contributors to the butylenes yield. Both the first component and second component are believed to contribute to the butylenes to propylene selectivity ratio, with the second component's contribution being more significant because of its greater activity.

The FCC additive composition may be designed and customized to enhance the catalytic cracking performance of a base FCC catalyst component or of a base FCC catalyst composition. For instance, addition of the FCC additive composition to base FCC catalyst component or of a base FCC catalyst composition, prior to the cracking process or during the FCC process, exhibits improved total butylenes yield and improved butylenes to propylene selectivity ratio without compromising coke and bottom yields and selectivities, as compared to conducting the FCC process with the base FCC catalyst component or with the base FCC catalyst composition alone without the FCC additive composition.

Any of the first components described herein may be added to the FCC additive composition in an amount ranging from any of about 45 wt %, about 50 wt %, about 55 wt %, about 60 wt %, about 65 wt %, about 70 wt % to any of about 75 wt %, about 80 wt %, about 85 wt %, about 90 wt %, or about 95 wt %, based on total weight of the FCC additive composition. In certain embodiments, any of the first components described herein may be present in the FCC additive composition in an amount ranging from about 45 wt % to about 95 wt %, from about 50 wt % to about 90 wt %, from about 55 wt % to about 85 wt %, or from about 60 wt % to about 80 wt %, or any sub-range or single value therein, based on total weight of the FCC additive composition.

Any of the second components described herein may be added to the FCC additive composition in an amount ranging from any of about 5 wt %, about 6 wt %, about 7 wt %, about 8 wt %, about 9 wt %, about 10 wt %, about 11 wt %, about 12 wt %, or about 13 wt % to any of about 14 wt %, about 15 wt %, about 16 wt %, about 17 wt %, about 18 wt %, about 19 wt %, about 20 wt %, about 21 wt %, about 22 wt %, about 23 wt %, about 24 wt %, or about 25 wt %, based on total weight of the FCC additive composition. In certain embodiments, any of the second components described herein may be present in the FCC additive composition in an amount ranging from about 5 wt % to about 25 wt %, from about 8 wt % to about 20 wt %, from about 10 wt % to about 18 wt %, or from about 12 wt % to about 15 wt %, or any sub-range or single value therein, based on total weight of the FCC additive composition.

Any of the third components described herein may be present in the FCC additive composition in an amount ranging from any of 0 wt %, about 5 wt %, about 10 wt %, about 15 wt %, about 20 wt %, or about 25 wt % to any of about 28 wt %, about 30 wt %, about 33 wt %, about 35 wt %, about 38 wt %, or about 40 wt %, based on total weight of the FCC additive composition. In certain embodiments, any of the third component described herein may be present in the FCC additive composition in an amount ranging from about 5 wt % to about 35 wt %, from about 10 wt % to about 30 wt %, or from about 15 wt % to about 28 wt %, or any sub-range or single value therein, based on total weight of the FCC additive composition. In an embodiment, the third component may be present in the FCC additive composition in an amount of up to 40 wt %, based on the total weight of the FCC additive composition. In an embodiment, the FCC additive composition is free of a third component.

In one embodiment, the FCC additive composition includes about 45 wt % to about 95 wt % of a first component comprising beta zeolite and a first matrix, based on total weight of the FCC additive composition; about 5 wt % to about 25 wt % of a second component comprising ZSM-5 zeolite and a second matrix, based on total weight of the FCC additive composition; and up to about 40 wt % of a third component comprising Y zeolite and a third matrix, based on total weight of the FCC additive composition, wherein the weight ratio of the first component to the second component ranges from about 2:1 to about 9:1. Other sub-ranges for the concentrations of the various components and/or for the ratios of the various components may also be suitable, as described herein.

Without being construed as limiting, it is believed that, in certain embodiments, the second component provides for the highest total butylenes (TC4=) yield out of the three component in the FCC additive composition. However, the high total butylenes yield obtained with the second component is also accompanied by a high propylene yield and a low butylenes to propylene selectivity as compared to the butylenes to propylene selectivity of the first component. In certain embodiments, it is believed, without being construed as limiting, that the first component provides for the highest butylenes to propylene selectivity ratio out of the three components in the FCC additive composition. In certain embodiments, the weight ratio of the first component to the second components ranges from 2:1 to about 9:1, from about 2.5:1 to about 8.5:1, from about 3:1 to about 8:1, from about 3.5:1 to about 7:1, or from about 4:1 to about 6:1. It is believed, without being construed as limiting, that such ratios contribute to improved conversion, butylenes to propylene selectivity ratio, and total butylenes yield, while maintaining or reducing the yield and/or selectivity of less desired products, such as coke.

In one embodiment, the weight ratio of the first component to the second components ranges from 2:1 to about 9:1. In one embodiment, the weight ratio of the first component to the second components ranges from about 2.5:1 to about 8.5:1. In one embodiment, the weight ratio of the first component to the second components ranges from about 3:1 to about 8:1. In one embodiment, the weight ratio of the first component to the second components ranges from about 3.5:1 to about 7:1. In one embodiment, the weight ratio of the first component to the second components ranges from about 4:1 to about 6:1. The ratio of the first component to the second component being high enough to provide for a high butylenes to propylene selectivity ratio and a high total butylenes yield, without compromising the selectivity and yield of less desirable products such as coke and bottoms.

In certain embodiments, the FCC additive composition may be free of a third component. In alternative embodiments, the FCC additive composition may include a third component in an amount that is between the amount of the first component and the amount of the second component, such that, e.g., the FCC additive composition includes the greatest amount of a first component, an intermediate amount of a second component, and a lowest amount of the third component.

In certain embodiments, the FCC additive composition includes the three component in a weight ratio of the first component to the second component to the third component ranging from about 2:1:1 to about 9:1:8.5, from about 2.5:1:1 to about 8.5:1:8, from about 3:1:1.5 to about 8:1:7.5, from about 3.5:1:1.5 to about 7:1:6.5, or from about 4:1:1.5 to about 6:1:5.5. In one embodiment, the weight ratio of the first component to the second component to the third component in the FCC additive composition ranges from about 2:1:1 to about 9:1:8.5. In one embodiment, the weight ratio of the first component to the second component to the third component in the FCC additive composition ranges from about 2.5:1:1 to about 8.5:1:8. In one embodiment, the weight ratio of the first component to the second component to the third component in the FCC additive composition ranges from about 3:1:1.5 to about 8:1:7.5. In one embodiment, the weight ratio of the first component to the second component to the third component in the FCC additive composition ranges from about 3.5:1:1.5 to about 7:1:6.5. In one embodiment, the weight ratio of the first component to the second component to the third component in the FCC additive composition ranges from about 4:1:1.5 to about 6:1:5.5. It is believed, without being construed as limiting, that such ratios contribute to improved conversion, butylenes to propylene selectivity ratio, and total butylenes yield, while maintaining or reducing the yield and/or selectivity of less desired products, such as coke.

In certain embodiments, the FCC additive composition is free or substantially free of rare earth metals.

In certain embodiments, the FCC additive composition may further include at least one additional component that is compositionally different from the first component, the second component, and the third component. In certain embodiments, the at least one additional component includes a zeolite selected from zeolites with the structure BEA, MSE, -SVR, FAU, MOR, CON, SOF, MFI, IMF, FER, MWW, MTT, TON, EUO, MRE, NAT, CHA, or a combination thereof.

In certain embodiments, the instant disclosure is directed to a method of making any of the FCC additive compositions described herein. The method includes blending any of the first components described herein, which include a beta zeolite and a first matrix, with any of the second components described herein, which include a ZSM-5 zeolite and a second matrix, and further, if a third component is present, with any of the third components described herein, which include a Y zeolite and a third matrix. The components may be blended in any of the corresponding concentrations and or ratios described herein. For instance, the third component may be blended at an amount of up to 40 wt % based on total weight of the FCC additive composition. In another example, the first component and the second component may be blended at a weight ratio ranging from about 2:1 to about 9:1.

In certain embodiments, the method of making the FCC additive composition may further include, prior to blending, preparing one or more of the first component, the second component, or the third component. Preparing any one of these components may be done in accordance with the methods described herein or in accordance with other suitable methods, as recognized by those skilled in the art.

### FCC Catalyst Composition

In certain embodiments, the instant disclosure is directed to an FCC catalyst composition that includes any of the FCC additive compositions described herein in combination with a base catalyst composition.

Any of the FCC additive compositions described herein may be included in the FCC catalyst composition in an amount ranging from any of 1 wt %, about 3 wt %, about 5 wt %, about 7 wt %, about 10 wt %, or about 15 wt % to any of about 18 wt %, about 20 wt %, about 23 wt %, about 25 wt %, about 28 wt %, or about 30 wt %, based on total weight of the FCC catalyst composition. In certain embodiments, any of the FCC additive compositions described herein may be present in the FCC catalyst composition in an amount ranging from about 1 wt % to about 30 wt %, from about 5 wt % to about 25 wt %, or from about 10 wt % to about 20 wt %, or any sub-range or single value therein, based on total weight of the FCC catalyst composition.

Any suitable base catalyst composition may be included in the FCC catalyst composition in an amount ranging from any of 70 wt %, about 72 wt %, about 75 wt %, about 77 wt %, about 80 wt %, or about 82 wt % to any of about 85 wt %, about 90 wt %, about 93 wt %, about 95 wt %, about 97 wt %, or about 99 wt %, based on total weight of the FCC catalyst composition. In certain embodiments, any suitable base catalyst composition may be present in the FCC catalyst composition in an amount ranging from about 70 wt % to about 99 wt %, from about 75 wt % to about 95 wt %, or from about 80 wt % to about 90 wt %, or any sub-range or single value therein, based on total weight of the FCC catalyst composition.

The base catalyst composition may include any base cracking catalyst component having a significant activity (e.g., zeolite Y, dealuminated zeolite Y, silica-enriched dealuminated zeolite Y, REY, USY, CREY, REUSY, and the like). For instance, suitable base cracking catalyst components may be described generally as a catalyst component containing a crystalline aluminosilicate, ammonium exchanged and at least partially exchanged with rare earth metal cations, and sometimes referred to as “rare earth-exchanged crystalline aluminum silicate,” i.e. REY, CREY, or REUSY; or one of the stabilized ammonium or hydrogen zeolites.

In certain embodiments, the FCC catalyst composition may further include at least one additional component that is compositionally different from the components in the FCC additive composition and from the components in the base catalyst composition. In certain embodiments, the at least one additional component includes a zeolite selected from zeolites with the structure BEA, MSE, -SVR, FAU, MOR, CON, SOF, MFI, IMF, FER, MWW, MTT, TON, EUO, MRE, NAT, CHA, or a combination thereof.

The FCC catalyst composition may be formed by blending or mixing (e.g., physically mixing) any of the FCC additive compositions described herein and any suitable base FCC catalyst component or base FCC catalyst composition at any of the concentrations described hereinabove. For instance, in one embodiment, the method of making an FCC catalyst composition includes blending about 70 wt % to about 99 wt % of a base catalyst composition, based on total weight of the FCC catalyst composition, and about 1 wt % to about 30 wt % of any of the FCC additive compositions described herein, based on total weight of the FCC catalyst composition.

The FCC catalyst composition may be further include, in addition to the FCC additive composition and the base FCC catalyst composition, further blending or mixing (e.g., physically mixing) any of the at least one additional components described herein.

The FCC additive composition and/or the base FCC catalyst composition and/or the at least one additional component may be formulated as separate and distinct particles, which may be add to the FCC catalyst composition as needed to provide a customized catalyst solution. For instance, the FCC additive composition may be designed to exhibit enhanced butylenes specific performance, such as improved total butylenes yield and improved butylenes to propylene selectivity ratio without compromising yield and selectivity of less desired products (e.g., bottoms and coke).

The base FCC catalyst composition may be designed exhibit optimal FCC performance without compromising yield and selectivity of less desired products (e.g., bottoms and coke).

The at least one additional component may be added to improve the activity of the FCC catalyst composition through the combination of, for example, multiple zeolitic framework structures.

In certain embodiments, the amount of the base catalyst composition in the FCC catalyst composition is greater than the amount of the FCC additive composition. For instance, the wt:wt ratio of the base catalyst composition to the FCC additive composition in the FCC catalyst composition may range from about 50:1 to about 1.5:1, from about 40:1 to about 2:1, or from about 30:1 to about 3:1, or any sub-range or single weight ratio therein.

### Method of Use

Each FCC unit has a unique capacity and hydrocarbon feed, which means that a variety of FCC catalyst compositions containing different amounts of FCC additive compositions are needed. For example, some feeds may require more of the FCC additive compositions described herein, while other hydrocarbon feeds may require less of the FCC additive compositions described herein. Furthermore, even in the same FCC unit, the FCC catalyst composition in the unit may degrade over time, and it may be desirable to increase or decrease the amount of FCC additive composition in the unit to enhance the performance of a particular process at a particular time. Unlike a base catalyst composition, which is added into an FCC unit at the beginning of the FCC process and cannot be adjusted during processing, the FCC additive composition, may be added separately into an FCC unit, e.g., using a separate hopper, and the amount of the FCC additive composition can be added at different times during the FCC processing and at different amounts depending on the operational objective at a given time. The FCC additive compositions described herein may be viewed as a “knob” that one can turn to improve butylenes specific activity, total butylenes yield, butylenes to propylene selectivity ratio, or adjust the mode of operation. The FCC additive compositions described herein compliment the base catalyst composition and work in conjunction with the base catalyst composition, at least because it is used to tune the performance of the base catalyst composition. However, the FCC additive compositions described herein do not replace the base catalyst composition altogether.

Hence, embodiments of the instant disclosure are directed to a method of cracking a hydrocarbon feed under FCC conditions by adding any of the FCC additive compositions described herein to a base catalyst composition in an FCC unit, e.g., before fluid catalytic cracking begins or during the fluid catalytic cracking. In other embodiments of the instant disclosure, the FCC additive compositions described herein are added to a base catalyst composition to form a FCC catalyst composition, outside of an FCC unit, and then the FCC catalyst composition is added, as a whole, to the FCC unit to process with the fluid catalytic cracking.

In certain aspects, the instant disclosure is directed to a method of cracking a hydrocarbon feed by contacting said feed with any of the FCC additive compositions described herein and/or any of the FCC catalyst compositions described herein.

In certain embodiments, the methods of cracking a hydrocarbon feed, as described herein, result in increase in the average butylenes to propylene selectivity ratio, when compared to the average butylenes to propylene selectivity ratio attained from cracking the hydrocarbon feed with a base catalyst composition and without any of the FCC additive compositions described herein. In certain embodiments, the methods of cracking a hydrocarbon feed, as described herein, result in an average butylenes to propylene selectivity ratio that is greater than about 1, greater than about 1.05, or greater than about 1.1. In one embodiment, the method of cracking a hydrocarbon feed, as described herein, results in an average butylene to propylene selectivity ratio that is about 1 or greater. In one embodiment, the method of cracking a hydrocarbon feed, as described herein, results in an average butylenes to propylene selectivity ratio that is about 1.05 or greater. In one embodiment, the method of cracking a hydrocarbon feed, as described herein, results in an average butylenes to propylene selectivity ratio that is about 1.1 or greater.

In certain embodiments, the methods of cracking a hydrocarbon feed, as described herein, result in increase in the total butylenes yield, when compared to the total butylenes yield attained from cracking the hydrocarbon feed with a base catalyst composition and without any of the FCC additive compositions described herein.

In certain embodiments, the method of cracking a hydrocarbon feed, as described herein, results in a substantially constant or lower total bottoms yield as compared to a total bottoms yield obtained from cracking the hydrocarbon feed under FCC conditions with the base catalyst composition and without the FCC additive composition.

### ILLUSTRATIVE EXAMPLES

The following examples are set forth to assist in understanding the disclosure and should not be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

### Example 1: Preparing a First Component

A first component was prepared as described in U.S. Pat. No. 9,227,181 (e.g., in column 9, line 23 through column 10, line 24), which is hereby incorporated by reference herein in its entirety.

First microspheroidal particles (beta zeolite microspheres) with various binders were evaluated to determine the dose required for producing 0.5 wt % and 1 wt % incremental increase in total butylenes (TC4=) by ACE doping. ACE doping was used to assess the activity and selectivity of the beta zeolite microspheres. ACE doping was done at constant base catalyst/oil ratio, but with increasing levels of beta zeolite microspheres, and measuring the resulting incremental yields of butylenes and propylene. The microspheres contained 40 wt % of beta zeolite. The binders that were evaluated included boehmite and phosphoric acid (H₃PO₄) which ultimately formed AlPO₄, silica-alumina binder with ammonium phosphate treatment which may also be referred to herein as a “phosphate treated component” (PT, U.S. Pat. No. 8,940,652 B2), and silica alumina binder without ammonium phosphate treatment (SiO₂). The results are summarized in Table 1.

TABLE 1
40 wt % Beta Zeolite Microspheres Dosage for Producing 0.5 wt %
and 1 wt % of Incremental Total Butylenes (TC4=) By ACE Doping

| | Dose for | Dose for | Wt % beta | |
|---|---|---|---|---|
| | 0.5 wt % | 1 wt % | crystal | Brönsted |
| | TC4 = increase | TC4 = increase | in FCC | acidity |
| | (%) | (%) | (%) | (μmol/g) |
| Boehmite + | 3.95-7.20 | 9-16 | 3.9-6.2 | 40-60 |
| H₃PO₄ (AlPO₄) | | | | |
| PT | 9-18.4 | 37 | 15 | 15-25 |
| SiO₂ | 7-24.4 | 49 | 20 | 25-40 |

The results in Table 1 show that the boehmite and phosphoric acid binder (AlPO₄) reduced the required additive dose (i.e., required amount of beta zeolite microspheres) for producing a 0.5 wt % and 1 wt % of incremental increase in total butylenes yield (TC4=) and improved the butylenes activity and increased Brönsted acidity values. This has the advantage of forming a more economical first component as it would allow usage of a lower amount of the second component in the FCC additive composition.

### Example 2: Effect of Boehmite and P₂O₅ on Attrition and Butylenes Activity in First Component

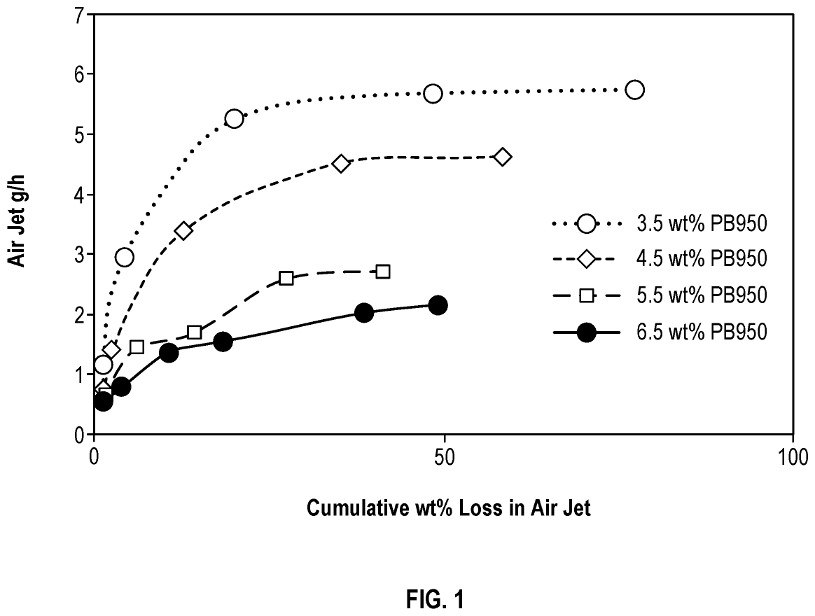

The effect of P₂O₅ and boehmite on butylenes activity and attrition of the first component was evaluated by varying boehmite and P₂O₅ simultaneously in a statistically designed experiment. Samples with boehmite content of 3.5 wt %, 4.5 wt %, and 5.5 wt % were tested over a range of 10.2 to 12.7 wt % P₂O₅. As can be seen in Table 2 and in FIG. 1, lowering the boehmite content affected the attrition of the second component, evidenced by increased air jet attrition rate (AJAR) and air jet index (AJI). Statistical analysis showed that the attrition resistance could be fitted with a simple quadratic in VF boehmite, and that P₂O₅ played no discernable role. There was also no statistically significant variation in butylenes over the range studied.

TABLE 2
Effect of Boehmite and P₂O₅ on Attrition and Butylenes
Activity in First Component

| | Boehmite | P₂O₅ | | | | | | % ZSA |
|---|---|---|---|---|---|---|---|---|
| Sample | (wt %) | (wt %) | AJI | AJAR | D50 | ZSA | SZSA | retained |
| 1 | 4.50 | 12.73 | 8.8 | 2.0 | 91 | 143 | 126 | 88% |
| 2 | 3.50 | 12.09 | 18.9 | 4.4 | 84 | 142 | 127 | 90% |
| 3 | 5.50 | 10.46 | 7.1 | 1.6 | 87 | 159 | 121 | 76% |
| 4 | 4.50 | 10.99 | 8.0 | 1.8 | 87 | 153 | 124 | 81% |
| 5 | 5.50 | 11.58 | 6.0 | 1.3 | 83 | 156 | 126 | 80% |
| 6 | 3.50 | 10.16 | 17.4 | 4.0 | 87 | 153 | 123 | 81% |

### Example 3: Preparing a Third Component

A third component was prepared as described herein and as described in U.S. Pat. No. 4,493,902 and/or in U.S. Pat. No. 6,656,347 and/or in U.S. Pat. No. 6,942,784 and/or in U.S. Pat. No. 6,716,338 and/or in U.S. Pat. No. 10,633,596, which are hereby incorporated by reference herein in their entireties. Exemplary matrix compositions for suitable third components are shown in Table 3.

TABLE 3
Exemplary Third Matrix Compositions for A Third Component
(wt % being based on the total weight of the third matrix)

| | | | | wt % Boehmite | | Suggested Calcination |
|---|---|---|---|---|---|---|
| Sample | wt % Metakaolin | wt % Spinel | wt % Mullite | Alumina | wt % Binder | Temperature (º F.) |
| 1 | 0% | 100% | — | — | — | 1800-1900 |
| 2 | 100% | 0% | — | — | 2% | 1350-1500 |
| 3 | 0% | — | 100% | — | — | >1900 |
| 4 | — | 75%-85% | — | 15%-25% | 0.2%-1.5% | 1800-1900 |
| 5 | 35%-40% | — | 60%-65% | — | 5%-10% | 1350-1500 |
| 6 | 55%-65% | 40%-45% | — | — | 2%-8% | 1350-1500 |
| 7 | 35%-40% | — | 35%-40% | 20%-25% | 10%-20% | 1350-1500 |

### Example 4: Preparing a Third Component

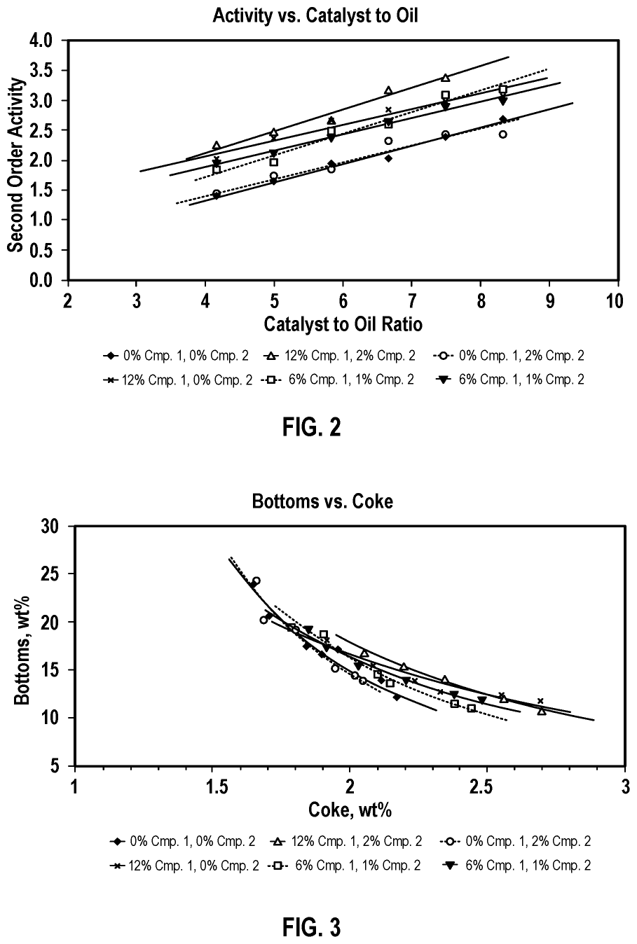

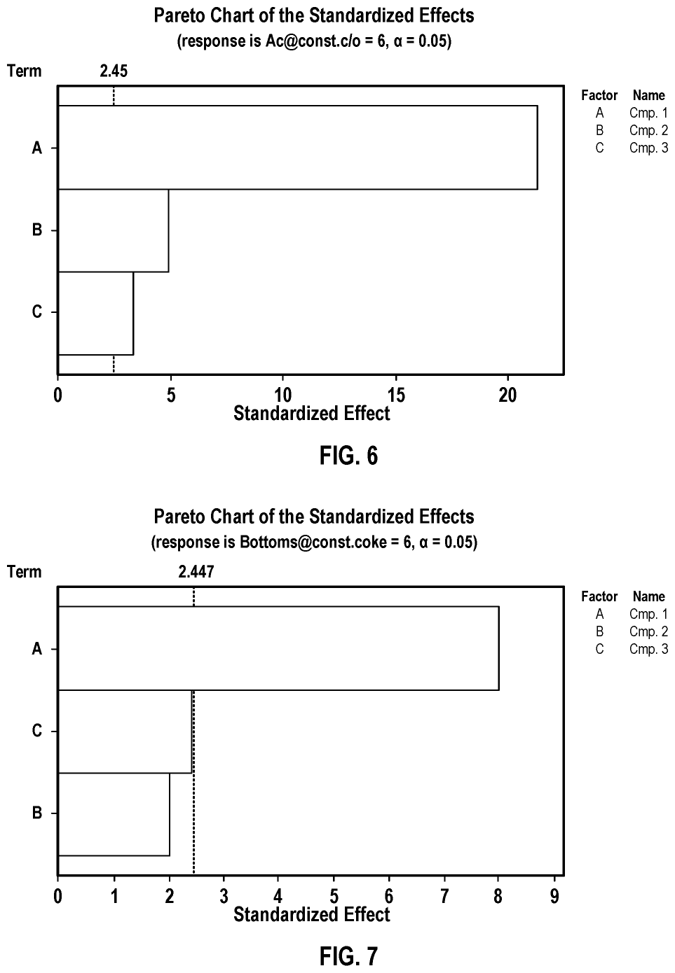

A design of experiments study was conducted on various FCC additive compositions to determine the effect that each component has on the activity, bottoms upgrade, total butylenes yield, and butylenes to propylene selectivity ratio, in order to enable customization of an FCC additive composition to a given operational objective. Twelve experiments were run, with varying concentration of the base catalyst composition, the first component (including beta zeolite and a first matrix), the second component (including ZSM-5 zeolite and a second matrix), and the third component (including Y zeolite and a third matrix), as summarized in Table 4 below. All FCC catalyst compositions for first subjected to 100% steam at 1450° C. for 24 hours before performing two ACE sets following CTOS protocol. The data that was obtained is shown in FIGS. 2-5 and the minitab analysis of the data is showing in FIGS. 6-9, all of which are discussed in more detail below.

TABLE 4
Design of Experiments FCC Catalyst
Compositions Over Twelve Runs

| | Base Catalyst | First | Second | Third |
|---|---|---|---|---|
| | Composition | Component | Component | Component |
| Run | (wt %) | (wt %) | (wt %) | (wt %) |
| 1 | 82 | 12 | 0 | 6 |
| 2 | 90 | 6 | 1 | 3 |
| 3 | 92 | 0 | 2 | 6 |
| 4 | 90 | 6 | 1 | 3 |
| 5 | 100 | 0 | 0 | 0 |
| 6 | 86 | 12 | 2 | 0 |
| 7 | 88 | 12 | 0 | 0 |
| 8 | 90 | 6 | 1 | 3 |
| 9 | 90 | 6 | 1 | 3 |
| 10 | 94 | 0 | 0 | 6 |
| 11 | 80 | 12 | 2 | 6 |
| 12 | 98 | 0 | 2 | 0 |

FIG. 2 depicts a plot of the activity as a function of catalyst to oil ratio for various FCC additive compositions. As can be seen in FIG. 2, the greatest butylenes specific activity is exhibited with FCC additive compositions that include the highest concentration of the first component (including beta zeolite and a first matrix). As the concentration of the first component decreases, so does the butylenes specific activity. This is further supported in FIG. 6, which depicts a pareto chart of the standardized effects of the first component, second component, and third component in the FCC additive composition on the activity of the FCC additive composition. The pareto chart in FIG. 6, confirms that the content of the first component in the FCC additive composition is the most significant factor for butylenes specific activity, though the second component and the third component also provide some contribution to the butylenes specific activity of the FCC additive composition.

FIG. 3 depicts a plot of the bottoms upgrading for various FCC additive compositions. As can be seen in FIG. 3, the greatest bottoms upgrading is exhibited with FCC additive compositions that include the highest concentration of the first component (including beta zeolite and a first matrix). As the concentration of the first component decreases, so does the bottoms upgrading. This is further supported in FIG. 7, which depicts a pareto chart of the standardized effects of the first component, second component, and third component in the FCC additive composition on the bottoms upgrading of the FCC additive composition. The pareto chart in FIG. 7, confirms that the content of the first component in the FCC additive composition is the only significant factor for bottoms upgrading from the FCC additive composition.

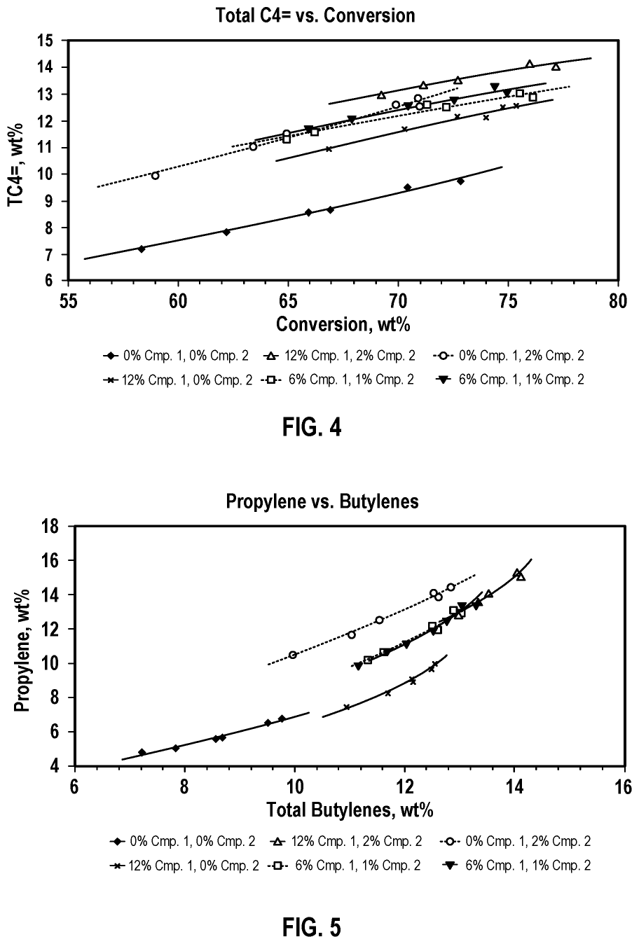

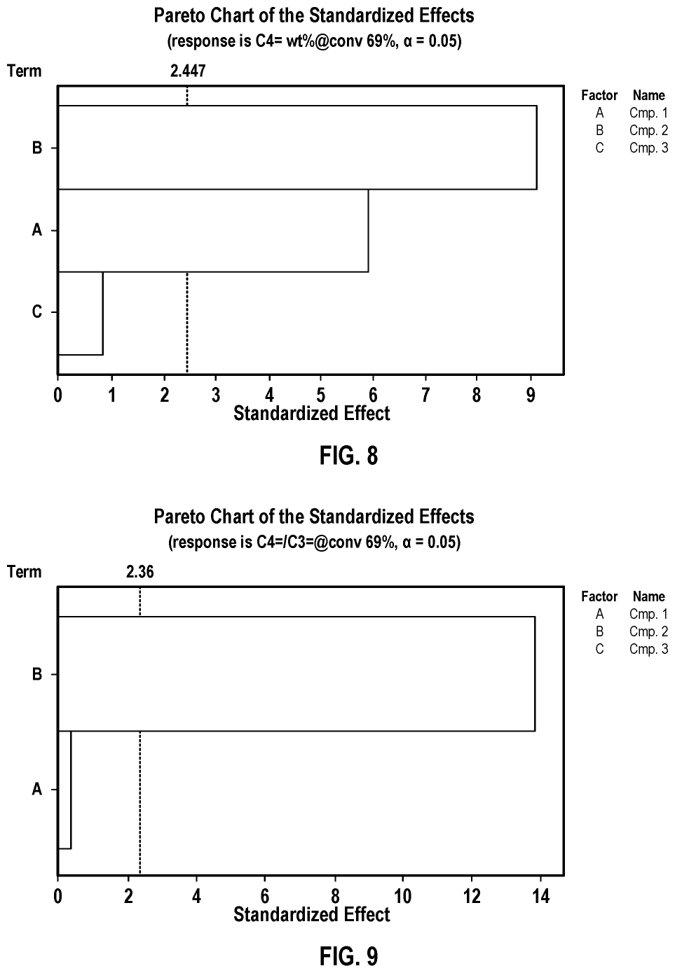

FIG. 4 depicts a total butylenes yield as a function of conversion for various FCC additive compositions. As can be seen in FIG. 4, the greatest total butylenes yield is exhibited with FCC additive compositions that include the highest concentration of the first component (including beta zeolite and a first matrix) and the second component (including ZSM-5 zeolite and a second matrix). As the concentration of the first component and/or of the second component decreases, so does the total butylenes yield. This is further supported in FIG. 8, which depicts a pareto chart of the standardized effects of the first component, second component, and third component in the FCC additive composition on the total butylenes yield of the FCC additive composition. The pareto chart in FIG. 8, confirms that the content of the first component and the content of the second component in the FCC additive composition are both significant factor for for the total butylenes yield of the FCC additive composition.

FIG. 5 depicts a propylene versus butylenes plot for various FCC additive compositions. As can be seen in FIG. 5, the first component has the greatest butylenes to propylene selectivity ratio but the second component exhibits the greatest total butylenes yield. The content of the first component and of the second component in the FCC additive composition need to be selected to balance the total butylenes yield and the butylenes to propylene selectivity ratio based on operational objectives. FIG. 9 depicts a pareto chart of the standardized effects of the first component, second component, and third component in the FCC additive composition on the butylenes to propylene selectivity ratio of the FCC additive composition. FIG. 9 indicates that the second component is the only significant factor with regard to the butylenes to propylene selectivity ratio due to its high activity.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present disclosure has been described with reference to specific exemplary embodiments thereof. The specification and drawings are, accordingly, to be regarded in an illustrative rather than a restrictive sense. Various modifications of the disclosure in addition to those shown and described herein will become apparent to those skilled in the art and are intended to fall within the scope of the appended claims.

1. A fluid catalytic cracking (FCC) additive composition comprising:
a first component comprising beta zeolite and a first matrix;
a second component comprising ZSM-5 zeolite and a second matrix; and
up to about 40 wt % of a third component comprising Y zeolite and a third matrix, based on total weight of the FCC additive composition,
wherein the weight ratio of the first component to the second component ranges from about 2:1 to about 9:1.

2. The FCC additive composition of claim 1, wherein the weight ratio of the first component to the second component ranges from about 2.5:1 to about 8.5:1.

3. The FCC additive composition of claim 1, wherein when the third component is present, the amount of the third component is between the amount of the first component and the amount of the second component, and wherein the weight ratio of the first component to the second component to the third component ranges from about 2:1:1 to about 9:1:8.5.

4. (canceled)

5. The FCC additive composition of claim 1, wherein the first component is present in the FCC additive composition in an amount ranging from about 45 wt % to about 95 wt %, based on total weight of the FCC additive composition.

6. The FCC additive composition of claim 1, wherein the second component is present in the FCC additive composition in an amount ranging from about 5 wt % to about 25 wt %, based on total weight of the FCC additive composition.

7. The FCC additive composition of claim 1, wherein the third component is present in the FCC additive composition in an amount ranging from about 5 wt % to about 35 wt %, based on total weight of the FCC additive composition.

8. The FCC additive composition of claim 1, wherein the additive composition is free of rare earth metals.

9. The FCC catalyst composition of claim 1, wherein the first matrix, the second matrix, and the third matrix comprise, independently, clay, silica stabilized gamma alumina, rare-earth doped alumina, silica-alumina, silica-doped alumina, gamma alumina, χ-alumina, δ-alumina, θ-alumina, κ-alumina, boehmite, mullite, kaolinite, halloysite, montmorillonite, bentonite, attapulgite, kaolin, amorphous kaolin, metakaolin, hydrous kaolin, gibbsite (alumina trihydrate), titania, alumina, silica, silica-alumina, silica-magnesia, magnesia, sepiolite, or a combination of any two or more thereof.

10. The FCC additive composition of claim 1, further comprising at least one additional component that is compositionally different from the first component, the second component, and the third component, wherein the at least one additional component comprises a zeolite selected from zeolites with the structure BEA, MSE, -SVR, FAU, MOR, CON, SOF, MFI, IMF, FER, MWW, MTT, TON, EUO, MRE, NAT, CHA, or a combination thereof.

11. (canceled)

12. The FCC additive composition of claim 1, wherein the first component comprises aluminum phosphate (AlPO₄) or amorphous aluminum phosphate at an amount of about 1 wt % to about 25 wt %, based on total weight of the first component.

13. The FCC additive composition of claim 1, wherein the first component further comprises one or more of oxidized phosphorous, phosphorous treated component, or a silica-alumina binder, wherein the first component comprises about 1 wt % to about 30 wt %, based on total weight of the first component, and wherein the first component is substantially free of a transitional alumina obtained by the calcination of a dispersible boehmite.

14. (canceled)

15. (canceled)

16. The FCC additive composition of claim 1, wherein the silica to alumina ratio (SAR) in the beta zeolite ranges from about 20 to about 300, wherein the zeolite surface area (ZSA) of the first component ranges from about 50 m²/g to about 300 m²/g, and wherein the steamed zeolite surface area (SZSA) of the first component ranges from about 50 m²/g to about 300 m²/g, after steaming in 100% steam at 1450° F. for 24 hours.

17. (canceled)

18. (canceled)

19. The FCC additive composition of claim 1, wherein at least about 65% of the ZSA of the first component is maintained after steaming in 100% steam at 1450° F. for 24 hours, wherein the Brönsted acidity of the first component ranges from about 10 μmol/g to about 65 μmol/g, and wherein the air jet attrition rate (AJAR) of the first component is less than about 5 wt %/hr.

20. (canceled)

21. (canceled)

22. The FCC additive composition of claim 1, wherein the ratio of Zeolite Surface Area (ZSA) to Matrix Surface Area (MSA) of the ZSM-5 zeolite in the second component is about 3.0 or less.

23. The FCC additive composition of claim 1, wherein the second component has a MSA of the ZSM-5 zeolite ranging from about 80 m²/g to about 190 m²/g, and wherein the second component has a specific pore volume of about 0.02 cm³/g to about 0.20 cm³/g.

24. (canceled)

25. The FCC additive composition of claim 1, wherein the Y zeolite in the third component comprises at least about 15 wt % Y-faujasite crystallized in-situ from a metakaolin-containing calcined microsphere, and wherein the third matrix comprises alumina obtained by the calcination of a dispersible boehmite contained in said microsphere, and wherein the third matrix comprises at least about 5 wt % of an alumina in a transitional gamma phase, delta phase, or a combination thereof.

26. (canceled)

27. A fluid catalytic cracking (FCC) catalyst composition comprising:
about 70 wt % to about 99 wt % base catalyst composition, based on total weight of the FCC catalyst composition; and
about 1 wt % to about 30 wt % FCC additive composition according to claim 1, based on total weight of the FCC composition.

28. (canceled)

29. (canceled)

30. A method of cracking a hydrocarbon feed under FCC conditions, the method comprising adding an FCC additive composition according to claim 1 to a base catalyst composition in a FCC unit.

31-35. (canceled)

36. A method of making a fluid catalytic cracking (FCC) additive composition, the method comprises blending:
a first component comprising beta zeolite and a first matrix,
a second component comprising ZSM-5 zeolite and a second matrix, and
up to about 40 wt % of a third component comprising Y zeolite and a third matrix, based on the total weight of the FCC additive composition,
wherein the weight ratio of the first component to the second component ranges from about 2:1 to about 9:1.

37. (canceled)

38. (canceled)

39. A fluid catalytic cracking (FCC) additive composition comprising:
about 45 wt % to about 95 wt % of a first component comprising beta zeolite and a first matrix, based on total weight of the FCC additive composition;
about 5 wt % to about 25 wt % of a second component comprising ZSM-5 zeolite and a second matrix, based on total weight of the FCC additive composition; and
up to about 40 wt % of a third component comprising Y zeolite and a third matrix, based on total weight of the FCC additive composition,
wherein the weight ratio of the first component to the second component ranges from about 2:1 to about 9:1.

40. (canceled)
